(19) United States
(12) Patent Application Publication
(10) Pub. No.: US 2014/0184833 A1
(43) Pub. Date: Jul. 3, 2014

(54) ELECTRONIC DEVICE FOR REFLECTING SPATIAL MOTION TO FOCUS SUBJECT AND METHOD THEREOF

(71) Applicant: Sumsung Electronics Co., Ltd, Gyeonggi-do (KR)

(72) Inventors: Kang-Min Lee, Gyeonggi-do (KR); Moon-Soo Kim, Seoul (KR); Yong-Gu Lee, Seoul (KR); Dong-Hoon Jang, Gyeonggi-do (KR); Sung-Jun Yim, Seoul (KR)

(73) Assignee: Sumsung Electronics Co., Ltd, Gyeonggi-do (KR)

(21) Appl. No.: 14/092,743

(22) Filed: Nov. 27, 2013

(30) Foreign Application Priority Data
Dec. 27, 2012 (KR) 10-2012-0154732

(51) Int. Cl. H04N 5/232

(52) U.S. Cl. CPC H04N 5/23212; H04N 5/23258; H04N 5/23254
USPC 348/208.1; 348/208.12; 348/208.2

(57) ABSTRACT

An electronic device for reflecting a spatial motion to focus a subject and a method thereof. A method of operating an electronic device includes sensing a spatial motion of the electronic device, at the same time as sensing the spatial motion, determining the movement or non-movement of a subject being displayed, and reflecting the spatial motion of the electronic device and the movement or non-movement of the subject to focus the subject.

### PRIORITY

The present application is related to and claims priority under 35 U.S.C. §119(a) to a Korean Patent Application filed in the Korean Intellectual Property Office on Dec. 27, 2012 and assigned Serial No. 10-2012-0154732, the contents of which are herein incorporated by reference.

### TECHNICAL FIELD

The present disclosure relates to an electronic device for auto focusing and a method thereof.

### BACKGROUND

Mostly, electronic devices being putting on the market are supported by high pixel and therefore, a user could get to substitute digital cameras with the electronic devices. For example, the user could get to experience a high definition image or video by virtue of the electronic device with a camera no less than the digital camera. Also, most of the electronic devices provide a function of automatically focusing a subject, improving a user's convenience.

But, the aforementioned auto focusing function increases a user's inconvenience because it cannot detect a motion of the electronic device and determines only a motion of the subject to focus a screen. For example, when the electronic device is moved while shooting a fixed subject, there was a problem that, as a focus value of the fixed subject does not vary, the electronic device fails to focus the fixed subject, although the electronic device has to newly focus the fixed subject as being moved.

Accordingly, there is a need to develop an apparatus and method capable of, when focusing a subject, an electronic device detects not only a motion of the subject but also a motion of the electronic device, improving a user's convenience.

### SUMMARY

To address the above-discussed deficiencies of the prior art, it is a primary object to provide an apparatus and method capable of simultaneously sensing a motion of an electronic device as well as the movement or non-movement of a subject to accurately focus the subject.

Another aspect of the present disclosure is to provide an apparatus and method capable of, upon shooting a still subject, accurately focusing the still subject irrespective of moving surrounding things.

A further aspect of the present disclosure is to provide an apparatus and method capable of, even when there is not a variation of a focus value, sensing a motion of an electronic device to automatically focusing a subject.

Yet another aspect of the present disclosure is to provide an apparatus and method for preventing the repetition of short-distance and long-distance images when an electronic device and a subject are concurrently moved.

The above aspects are achieved by providing an electronic device for reflecting a spatial motion to focus a subject, and a method thereof.

According to one aspect of the present disclosure, an operation method of an electronic device is provided. The method includes sensing a spatial motion of the electronic device, at the same time as sensing the spatial motion, determining the movement or non-movement of a subject being displayed, and reflecting the spatial motion of the electronic device and the movement or non-movement of the subject to focus the subject.

Sensing the spatial motion may sense whether there is the spatial motion by using an acceleration sensor and a gyro sensor.

Sensing the spatial motion may sense the spatial motion through a motion of a picture being displayed.

Determining the movement or non-movement of the subject being displayed may include detecting a first focus value of the subject being displayed, after the lapse of a set time, detecting a second focus value of the subject, and sensing a variation of the detected first focus value and second focus value to determine the movement or non-movement of the subject.

Sensing the variation of the detected first focus value and second focus value to determine the movement or non-movement of the subject may include sensing a variation of the detected first focus value and second focus value, and determining the movement or non-movement of the subject depending on whether the sensed variation is equal to or is greater than a set variation.

Determining the movement or non-movement of the subject depending on whether the sensed variation is equal to or is greater than the set variation may include identifying that the subject has been moved, when the sensed variation is determined equal to or greater than the set variation.

Determining the movement or non-movement of the subject depending on whether the sensed variation is equal to or is greater than the set variation may include identifying that the subject has been fixed when the sensed variation is determined less than the set variation.

Reflecting the spatial motion of the electronic device and the movement or non-movement of the subject to focus the subject may include capturing a first picture being displayed at a set first time, after the lapse of the set first time, capturing a second picture being displayed at a set second time, comparing the captured first picture and second picture to distinguish a moved first subject and a fixed second subject, and focusing the fixed second subject.

Reflecting the spatial motion of the electronic device and the movement or non-movement of the subject to focus the subject may include sensing that there is the spatial motion, sensing that the subject being displayed is being moved according to the sensed spatial motion, and focusing the subject being moved.

Reflecting the spatial motion of the electronic device and the movement or non-movement of the subject to focus the subject may include sensing that there is the spatial motion, concurrently with the spatial motion, sensing that the subject is being moved, and focusing the subject being moved.

According to another aspect of the present disclosure, an electronic device is provided. The device includes a processor unit for sensing a spatial motion of the electronic device, at the same time as sensing the spatial motion, determining the movement or non-movement of a subject being displayed, and reflecting the spatial motion of the electronic device and the movement or non-movement of the subject to focus the subject, and a memory for storing information controlled in the processor unit.

The processor unit may sense whether there is the spatial motion by using an acceleration sensor and a gyro sensor.

The processor unit may sense the spatial motion through a motion of a picture being displayed.

The processor unit may detect a first focus value of the subject being displayed, after the lapse of a set time, detect a second focus value of the subject, and sense a variation of the detected first focus value and second focus value to determine the movement or non-movement of the subject.

The processor unit may sense a variation of the detected first focus value and second focus value, and determine the movement or non-movement of the subject depending on whether the sensed variation is equal to or is greater than a set variation.

When the sensed variation is determined equal to or greater than the set variation, the processor unit may identify that the subject has been moved.

When the sensed variation is determined less than the set variation, the processor unit may identify that the subject has been fixed.

The processor unit may capture a first picture being displayed at a set first time, after the lapse of the set first time, capture a second picture being displayed at a set second time, compare the captured first picture and second picture to distinguish a moved first subject and a fixed second subject, and focus the fixed second subject.

The processor unit may sense that there is the spatial motion, sense that the subject being displayed is being moved according to the sensed spatial motion, and focus the subject being moved.

The processor unit may sense that there is the spatial motion, concurrently with the spatial motion, sense that the subject is being moved, and focus the subject being moved.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a general diagram describing an electronic device reflecting a spatial motion to focus a subject according to the present disclosure;

FIGS. 2A-C illustrate diagrams of an exemplary embodiment for automatically focusing when a subject is fixed in a state where there is not a spatial motion of an electronic device according to the present disclosure;

FIGS. 3A-B illustrate diagrams of an exemplary embodiment for automatically focusing when a subject is fixed in a state where there is a spatial motion of an electronic device according to the present disclosure;

FIGS. 4A-B illustrate diagrams of an exemplary embodiment for automatically focusing when a subject is moved in a state where there is a spatial motion of an electronic device according to the present disclosure;

FIG. 5 illustrates a flowchart of a method of operating an electronic device for automatically focusing when a subject is fixed in a state where there is not a spatial motion of the electronic device according to an exemplary embodiment of the present disclosure;

FIG. 6 illustrates a flowchart of a method of operating an electronic device for automatically focusing when a subject is fixed in a state where there is a spatial motion of the electronic device according to an exemplary embodiment of the present disclosure;

FIG. 7 illustrates a flowchart of a method of operating an electronic device for automatically focusing when a subject is moved in a state where there is a spatial motion of the electronic device according to an exemplary embodiment of the present disclosure;

FIG. 8A illustrates a flowchart of a method of operating an electronic device reflecting a spatial motion to focus a subject according to an exemplary embodiment of the present disclosure;

FIG. 8B illustrates a diagram of an apparatus of an electronic device reflecting a spatial motion to focus a subject according to an exemplary embodiment of the present disclosure;

FIG. 9 illustrates a block diagram of a construction of an electronic device according to an exemplary embodiment of the present disclosure.

### DETAILED DESCRIPTION

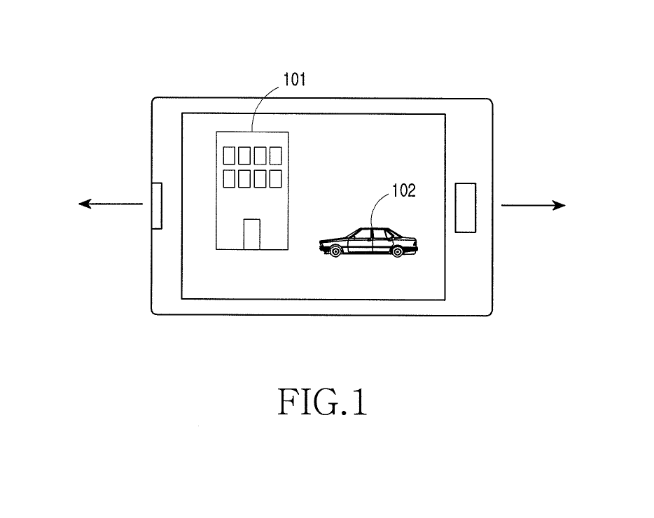

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Preferred embodiments of the present disclosure will be described herein below with reference to the accompanying drawings. In the following description, well-known functions or constructions are not described in detail since they would obscure the disclosure in unnecessary detail. And, terms described below, which are defined considering functions in the present disclosure, can be different depending on user and operator's intention or practice. Therefore, the terms should be defined on the basis of the disclosure throughout this specification.

FIG. 1 illustrates a general diagram for describing an electronic device reflecting a spatial motion to focus a subject according to the present disclosure.

First, the electronic device according to the present disclosure can sense a spatial motion of the electronic device. In detail, the electronic device according to the present disclosure can sense the spatial motion of the electronic device by using a sensor provided in the electronic device. Desirably, the electronic device may sense the spatial motion of the electronic device by using an acceleration sensor and a gyro sensor provided in the electronic device. Also, the electronic device can sense the spatial motion of the electronic device through a motion of a picture being displayed on a touch screen of the electronic device by using a camera module provided in the electronic device. That is, the electronic device can sense the spatial motion of the electronic device by using the acceleration sensor, the gyro sensor, and the camera module which are provided in the electronic device.

The electronic device having sensed the spatial motion of the electronic device can determine the movement or non-movement of a subject being displayed on the touch screen of the electronic device. In detail, the electronic device can detect a first focus value of the subject being displayed, after the lapse of a set time, detect a second focus value of the subject, and sense a variation of the detected first focus value and second focus value to determine the movement or non-movement of the subject. Here, sensing the variation of the first focus value and second focus value detected in the electronic device to determine the movement or non-movement of the subject can be defined as sensing the variation of the sensed first focus value and second focus value and then determining the movement or non-movement of the subject depending on whether the sensed variation is equal to or is greater than a set variation. That is, when the variation sensed in the electronic device is determined equal to or greater than the set variation, the electronic device can identify that the subject displayed on the touch screen of the electronic device has been moved. In the same meaning, when the variation sensed in the electronic device is determined less than the set variation, the electronic device can identify that the subject displayed on the touch screen of the electronic device has been fixed.

After that, the electronic device can reflect the spatial motion of the electronic device and the movement or non-movement of a subject to focus the subject. In detail, it can be three cases:

First case is that there is not the motion of the electronic device and the subject being displayed on the touch screen of the electronic device is fixed;

Second case is that there is the motion of the electronic device and the subject being displayed on the touch screen of the electronic device is fixed; and

Third case is that there is the motion of the electronic device and the subject being displayed on the touch screen of the electronic device is moved.

A description is made for the first case where there is not the motion of the electronic device and the subject being displayed on the touch screen of the electronic device is fixed.

First, the electronic device can capture a first picture being displayed at a set first time, capture a second picture being displayed at a set second time after the lapse of the set first time, compare the captured first picture and second picture to distinguish a moved first subject and a fixed second subject, and focus the fixed second subject. In detail, after identifying that there is not the motion of the electronic device, the electronic device can capture the first picture being displayed on the touch screen of the electronic device at the set first time. Next, the electronic device can capture the second picture being displayed at the set second time and then, compare the captured first picture and second picture to distinguish the moved first subject and the fixed second subject, and focus the fixed second subject. For example, assume that the electronic device is displaying only a subject 101 of the fixed building on the touch screen of the electronic device among two subjects 101 and 102 illustrated in FIG. 1, and there is not the motion of the electronic device. In the aforementioned assumption, the electronic device can reflect a spatial motion of the electronic device and the movement or non-movement of the subject to automatically focus the subject. In detail, after identifying that there is not the spatial motion of the electronic device, the electronic device can capture the subject 101 being displayed on the touch screen of the electronic device, at the respectively set first time and second time. After that, the electronic device can compare the captured first picture and second picture to distinguish a moved first subject and a fixed second subject, and focus the fixed second subject. In this exemplary embodiment, because only the one fixed subject 101 is being displayed on the touch screen of the electronic device, the electronic device can automatically focus the fixed subject 101 being the fixed second subject.

A description is made for the second case where there is the motion of the electronic device and the subject being displayed on the touch screen of the electronic device is fixed.

The electronic device can sense that there is the spatial motion of the electronic device and then sense that the subject being displayed is being moved according to the sensed spatial motion, to automatically focus the subject being moved. For example, assume that the electronic device is displaying only the subject 101 of the fixed building on the touch screen of the electronic device among the two subjects 101 and 102 illustrated in FIG. 1, and the electronic device is moving to the left or right. In the aforementioned assumption, the electronic device can sense that there is the motion of the electronic device. In detail, the electronic device can determine that there is the motion of the electronic device to the left or right by using an acceleration sensor, a gyro sensor and a camera module which are provided in the electronic device. After that, the electronic device can sense that the subject 101 being displayed on the touch screen of the electronic device is fixed but the subject 101 being displayed is being moved according to the motion of the electronic device. Finally, the electronic device can automatically focus the subject 101 which has been fixed itself but is being moved according to the spatial motion of the electronic device.

A description is made for the third case where there is the motion of the electronic device and the subject being displayed on the touch screen of the electronic device is moved.

The electronic device can sense that there is the spatial motion of the electronic device and then sense that the subject being displayed is being moved according to the sensed spatial motion, to automatically focus the subject being moved. For example, assume that the electronic device is displaying only the subject 102 of a car on the touch screen of the electronic device among the two subjects 101 and 102 illustrated in FIG. 1, and the electronic device is moving to the left or right. In the aforementioned assumption, the electronic device can sense that there is the motion of the electronic device. In detail, the electronic device can determine that there is the motion of the electronic device to the left or right by using an acceleration sensor, a gyro sensor and a camera module which are provided in the electronic device. After that, the electronic device can sense that the subject 102 being displayed on the touch screen of the electronic device is being moved. Finally, the electronic device can automatically focus the subject 102 being moved according to the spatial motion of the electronic device and the movement of the subject 102.

In the conventional electronic device, there was a problem that, when a user intended to shoot with a camera of the electronic device, the electronic device sensed only a motion of a subject being displayed on a touch screen of the electronic device to perform Continuous Auto Focusing (CAF). In detail, unlike the present disclosure, the conventional electronic device failed to sense a motion of the electronic device, and sensed only the motion of the subject being displayed on the touch screen of the electronic device to perform CAF. Accordingly, in the conventional electronic device, there was a problem of failing to perform CAF even when there was a need for execution of CAF because the electronic device was moved although there was not the motion of the subject being displayed on the touch screen of the electronic device. Unlike this, the electronic device according to the present disclosure has an advantage of being capable of sensing the motion of the electronic device by using a sensor and a camera module which are provided in the electronic device. In detail, the electronic device according to the present disclosure has an advantage of being capable of, even when the subject is fixed, performing CAF by sensing the motion of the electronic device by using the acceleration sensor, the gyro sensor, and the camera module which are provided in the electronic device.

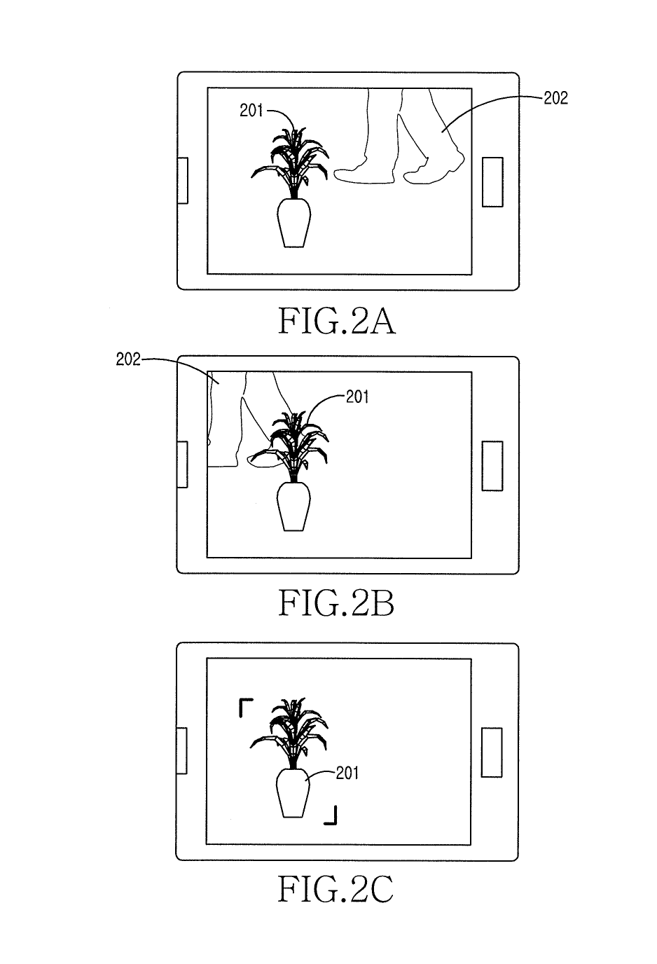

FIGS. 2A-C illustrate a diagram of an exemplary embodiment for automatically focusing when a subject is fixed in a state where there is not a spatial motion of an electronic device according to the present disclosure.

First, the electronic device can sense whether there is a spatial motion of the electronic device. In detail, the electronic device can sense the spatial motion of the electronic device by using a sensor and a camera module which are provided in the electronic device. That is, the electronic device according to the present disclosure can sense whether there is the spatial motion of the electronic device by using an acceleration sensor, a gyro sensor, and the camera module which are provided in the electronic device. After that, the electronic device can sense the movement or non-movement of a subject. In detail, the electronic device can determine whether the subject being displayed on a touch screen of the electronic device is a fixed subject or is a moving subject. First, the electronic device can capture a first picture being displayed at a set first time, capture a second picture being displayed at a set second time after the lapse of the set first time, compare the captured first picture and second picture to distinguish a moved first subject and a fixed second subject, and focus the fixed second subject. In detail, after identifying whether there is a spatial motion of the electronic device, the electronic device can capture the first picture being displayed on the touch screen of the electronic device at the set first time. Next, the electronic device can capture the second picture being displayed at the set second time and then, compare the captured first picture and second picture to distinguish the moved first subject and the fixed second subject, and focus the fixed second subject.

For example, as illustrated in FIGS. 2A to 2C, assume that there is not a spatial motion of the electronic device, and there are a fixed subject 201 and a moving subject 202 being displayed on a touch screen of the electronic device. Also, assume that a user has an intention to shoot the fixed subject 201 among the two subjects 201 and 202 being displayed on the touch screen of the electronic device. In the aforementioned assumption, as illustrated in FIG. 2A, the electronic device can capture a first picture being displayed at a set first time, and, as illustrated in FIG. 2B, the electronic device can capture a second picture being displayed at a set second time. After that, as illustrated in FIG. 2C, the electronic device having captured the first picture and the second picture can compare the captured first picture and second picture to distinguish the moved first subject 202 and the fixed second subject 201 and then, focus the fixed second subject 201.

In the conventional electronic device, there was a problem that, when a fixed subject and a moving subject were being displayed on a touch screen of the electronic device, despite a user's intention to shoot the fixed subject, the electronic device continuously performed CAF owing to the subject being moved. In detail, in the conventional electronic device, there was a problem that, although the electronic device was in a state of having focused the fixed subject being displayed on the touch screen of the electronic device, the electronic device continuously performed CAF according to unintentional surrounding things. Unlike this, the electronic device according to the present disclosure can capture a first picture being displayed at a set first time, after the lapse of the set first time, capture a second picture being displayed at a set second time, compare the captured first picture and second picture to distinguish a moved first subject and a fixed second subject, and focus the fixed second subject. Accordingly, the electronic device provides a solution to the problem that the electronic device continuously performs CAF according to moving surrounding things not intended by a user.

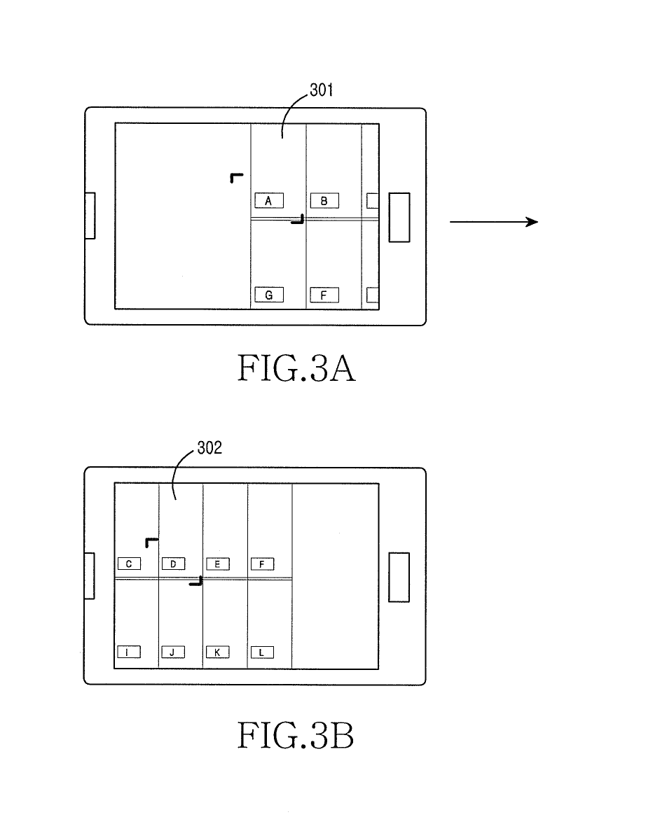

FIGS. 3A-B illustrate a diagram of an exemplary embodiment for automatically focusing when a subject is fixed in a state where there is a spatial motion of an electronic device according to the present disclosure.

First, the electronic device can sense whether there is a spatial motion of the electronic device. In detail, the electronic device can sense the spatial motion of the electronic device by using a sensor and a camera module which are provided in the electronic device. That is, the electronic device according to the present disclosure can sense whether there is the spatial motion of the electronic device by using an acceleration sensor, a gyro sensor, and the camera module which are provided in the electronic device. After that, the electronic device can sense the movement or non-movement of a subject. In detail, the electronic device can determine whether the subject being displayed on a touch screen of the electronic device is a fixed subject or is a moving subject.

For example, as illustrated in FIGS. 3A-B, assume that the electronic device has sensed a spatial motion of the electronic device being moving to the right, and has sensed that a subject being displayed on a touch screen of the electronic device has been fixed. In the aforementioned assumption, after sensing that there is the spatial motion of the electronic device, the electronic device can sense that the subject being displayed is being moved according to the sensed spatial motion, to automatically focus the subject being moved. For example, as illustrated in FIG. 3A, the electronic device can display a locker 301 which is a fixed subject on the touch screen of the electronic device. In detail, the electronic device can focus a locker 301 written with a name of “A” among lockers which are fixed subjects being displayed on the touch screen of the electronic device. After that, the electronic device can sense a spatial motion of the electronic device being moving to the right, to focus a locker 302 written with a name of “D” on a newly displayed screen. In detail, the electronic device can sense that the subject of the locker being displayed on the touch screen of the electronic device is fixed but the subject being displayed is being moved according to the motion of the electronic device. Finally, the electronic device can automatically focus the subject which has been fixed itself but is being moved according to the spatial motion of the electronic device.

In the conventional electronic device, there was a problem of failing to focus a subject of no difference of a focus value. In detail, the conventional electronic device failed to sense a spatial motion of the electronic device, and focused a screen according to the movement or non-movement of a subject being displayed on a touch screen of the electronic device. Accordingly, the conventional electronic device failed to automatically focus a newly displayed subject even when the result was that a locker of no difference of a focus value was moved according to the spatial motion of the electronic device on the touch screen of the electronic device as in this exemplary embodiment. Unlike this, the electronic device according to the present disclosure has an advantage of being capable of, although the subject being displayed on the touch screen of the electronic device is fixed, automatically focusing a subject being newly displayed on the touch screen of the electronic device because being capable of sensing the spatial motion of the electronic device.

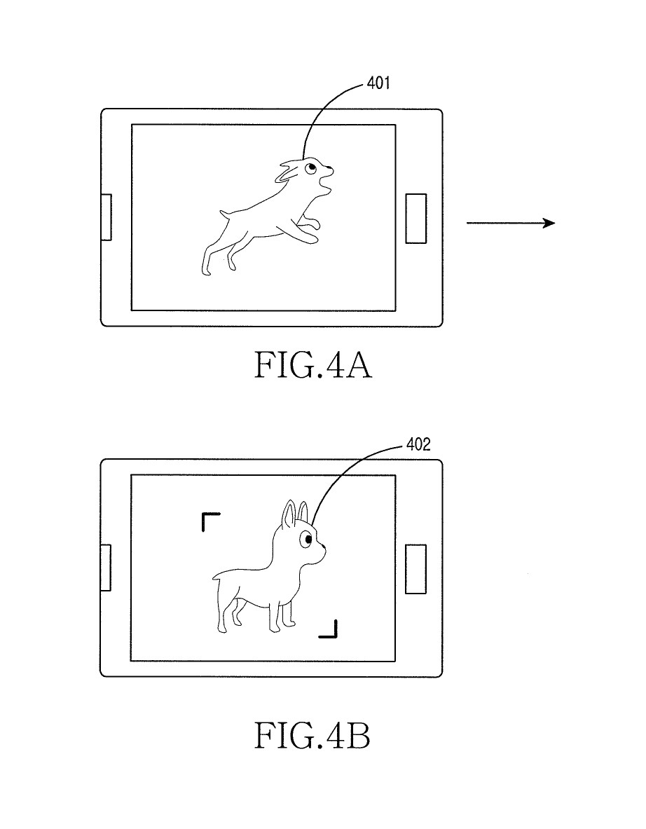

FIGS. 4A-B illustrate a diagram of an exemplary embodiment for automatically focusing when a subject is moved in a state where there is a spatial motion of an electronic device according to the present disclosure.

First, the electronic device can sense whether there is a spatial motion of the electronic device. In detail, the electronic device can sense the spatial motion of the electronic device by using a sensor and a camera module which are provided in the electronic device. That is, the electronic device according to the present disclosure can sense whether there is the spatial motion of the electronic device by using an acceleration sensor, a gyro sensor, and the camera module which are provided in the electronic device. After that, the electronic device can sense the movement or non-movement of a subject. In detail, the electronic device can determine whether the subject being displayed on a touch screen of the electronic device is a fixed subject or is a moving subject.

For example, as illustrated in FIGS. 4A-B, assume that the electronic device has sensed a spatial motion of the electronic device being moving to the right, and has sensed that a subject being displayed on a touch screen of the electronic device is moving. In the aforementioned assumption, after sensing that there is the spatial motion of the electronic device, the electronic device can sense the sensed spatial motion and that the subject being displayed is being moved, to automatically focus the subject being moved. For example, as illustrated in FIG. 4A and FIG. 4B, the electronic device may not perform CAF by sensing a spatial motion of the electronic device. In detail, the electronic device may not perform CAF by sensing the spatial motion of the electronic device irrespective of the movement or non-movement of a subject 401 or 402 being displayed on the touch screen of the electronic device.

The conventional electronic device failed to sense a spatial motion of the electronic device. In detail, the conventional electronic device sensed only the movement or non-movement of a subject being displayed on a touch screen of the electronic device irrespective of the spatial motion of the electronic device. In the aforementioned assumption, the conventional electronic device had a problem that, when the subject being displayed on the touch screen of the electronic device was moved, the electronic device continuously performed CAF because a range of a variation of a numeral obtained going through a filter provided in the electronic device was constant. In detail, because the range of the numeral obtained going through the filter of the electronic device was constant although the subject being displayed on the touch screen of the electronic device was moved, the conventional electronic device continuously performed CAF to focus the continuously moving subject. Accordingly, there was a problem that, when the electronic device played a taken video, the continuously performed CAF brought about a continuous change of screen focusing, causing inconvenience to a user who is seeing the played picture. Unlike this, the electronic device according to the present disclosure has an advantage of, the moment the electronic device senses a spatial motion of the electronic device, not performing CAF by sensing the spatial motion of the electronic device irrespective of the movement or non-movement of the subject being displayed on the touch screen of the electronic device.

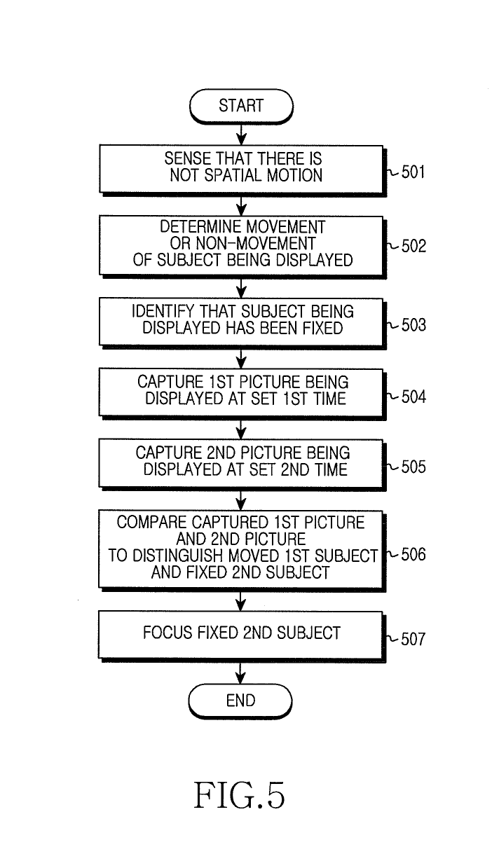

FIG. 5 illustrates a flowchart of a method of operating an electronic device for automatically focusing when a subject is fixed in a state where there is not a spatial motion of the electronic device according to an exemplary embodiment of the present disclosure.

As illustrated in FIG. 5, the electronic device can sense that there is not a spatial motion (step 501). In detail, the electronic device can sense the spatial motion of the electronic device by using an acceleration sensor, a gyro sensor, and a camera module which are provided in the electronic device. That is, in this exemplary embodiment, the electronic device can sense that there is not the spatial motion of the electronic device.

The electronic device having sensed that there is not the spatial motion can determine the movement or non-movement of a subject being displayed (step 502). In detail, the electronic device can determine whether the subject being displayed on a touch screen of the electronic device is a fixed subject or is a moving subject.

The electronic device having determined the movement or non-movement of the subject being displayed can identify that the subject being displayed has been fixed (step 503). In detail, when the subject is fixed, the electronic device can identify that the subject being displayed on the touch screen of the electronic device has been fixed.

After that, the electronic device can capture a first picture being displayed at a set first time (step 504). In detail, the electronic device can capture the first picture being displayed on the touch screen of the electronic device at the set first time. For example, when the set first time is three seconds, after the camera module is enabled, the electronic device can capture the first picture being displayed on the touch screen of the electronic device after the lapse of three seconds being the set first time.

The electronic device having captured the first picture being displayed at the set first time can capture a second picture being displayed at a set second time (step 505). In detail, the electronic device can capture the second picture being displayed on the touch screen of the electronic device at the set second time after the lapse of the set first time. For example, when the set second time is five seconds, after the camera module is enabled, the electronic device can capture the second picture being displayed on the touch screen of the electronic device after the lapse of five seconds being the set second time after capturing the first picture being displayed on the touch screen of the electronic device after the lapse of three seconds being the set first time.

Next, the electronic device can compare the captured first picture and second picture to distinguish a moved first subject and a fixed second subject (step 506). In detail, the electronic device can compare the first picture captured at the set first time and the second picture captured at the set second time, to distinguish the moved first subject and the fixed second subject.

Finally, the electronic device can focus the fixed second subject (step 507). In detail, the electronic device can distinguish the moved first subject and the fixed second subject to automatically focus the fixed second subject. In the conventional electronic device, there was a problem that, when a fixed subject and a moving subject were being displayed on a touch screen of the electronic device, despite a user's intention to shoot the fixed subject, the electronic device continuously performed CAF owing to the subject being moved. In detail, in the conventional electronic device, there was a problem that, although the electronic device was in a state of having focused the fixed subject being displayed on the touch screen of the electronic device, the electronic device continuously performed CAF according to unintentional surrounding things. Unlike this, the electronic device according to the present disclosure can capture a first picture being displayed at a set first time, after the lapse of the set first time, capture a second picture being displayed at a set second time, compare the captured first picture and second picture to distinguish a moved first subject and a fixed second subject, and focus the fixed second subject. Accordingly, the electronic device provides a solution to the problem that the electronic device continuously performs CAF according to moving surrounding things not intended by a user.

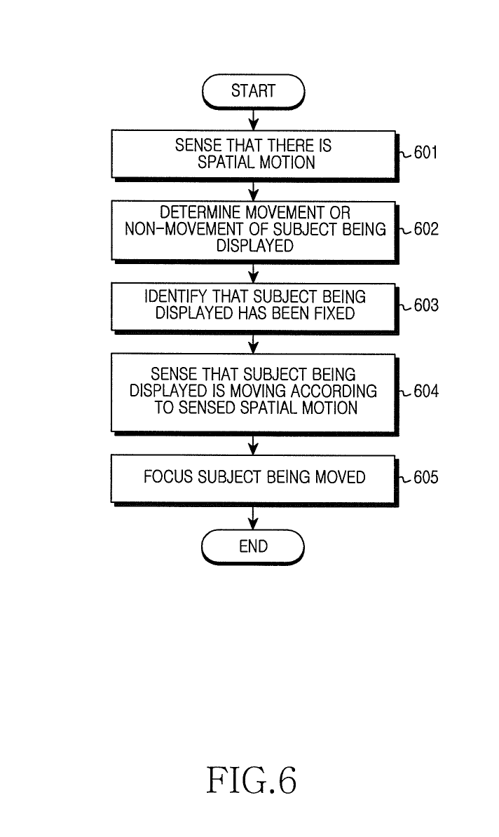

FIG. 6 illustrates a flowchart of a method of operating an electronic device for automatically focusing when a subject is fixed in a state where there is a spatial motion of the electronic device according to an exemplary embodiment of the present disclosure.

As illustrated in FIG. 6, the electronic device can sense that there is a spatial motion (step 601). In detail, the electronic device can sense the spatial motion of the electronic device by using an acceleration sensor, a gyro sensor, and a camera module which are provided in the electronic device. That is, in this exemplary embodiment, the electronic device can sense that there is the spatial motion of the electronic device.

The electronic device having sensed that there is the spatial motion of the electronic device can determine the movement or non-movement of a subject being displayed (step 602). In detail, the electronic device can determine whether the subject being displayed on a touch screen of the electronic device is a fixed subject or is a moving subject.

The electronic device having determined the movement or non-movement of the subject being displayed can identify that the subject being displayed has been fixed (step 603). In detail, when the subject is fixed, the electronic device can identify that the subject being displayed on the touch screen of the electronic device has been fixed.

After that, the electronic device can sense that the subject being displayed is being moved according to the sensed spatial motion (step 604). For example, assume that the electronic device has sensed a spatial motion of the electronic device being moving to the right, and has sensed that a subject being displayed on a touch screen of the electronic device has been fixed. In the aforementioned assumption, after sensing that there is the spatial motion of the electronic device, the electronic device can sense that the subject being displayed is being moved according to the sensed spatial motion, to automatically focus the subject being moved.

Finally, the electronic device can focus the moving subject (step 605). In detail, the electronic device can automatically focus the subject which has been fixed itself but is being moved according to the spatial motion of the electronic device. In the conventional electronic device, there was a problem of failing to focus a subject of no difference of a focus value. In detail, the conventional electronic device failed to sense a spatial motion of the electronic device, and focused a screen according to the movement or non-movement of a subject being displayed on a touch screen of the electronic device. Accordingly, the conventional electronic device failed to automatically focus a newly displayed subject even when the result was that a locker of no difference of a focus value was moved according to the spatial motion of the electronic device on the touch screen of the electronic device as in this exemplary embodiment. Unlike this, the electronic device according to the present disclosure has an advantage of being capable of, although the subject being displayed on the touch screen of the electronic device is fixed, automatically focusing a subject being newly displayed on the touch screen of the electronic device because being capable of sensing the spatial motion of the electronic device.

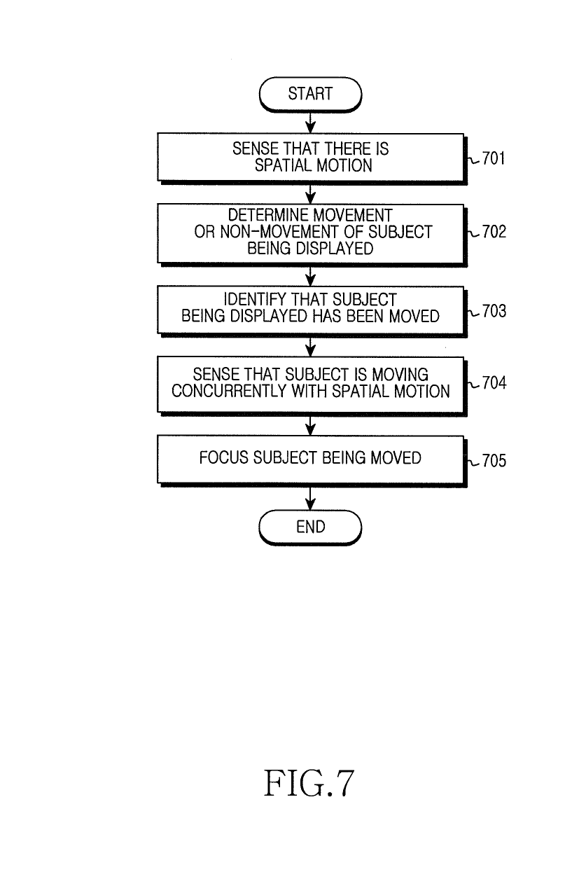

FIG. 7 illustrates a flowchart of a method of operating an electronic device for automatically focusing when a subject is moved in a state where there is a spatial motion of the electronic device according to an exemplary embodiment of the present disclosure.

As illustrated in FIG. 7, the electronic device can sense that there is a spatial motion (step 701). In detail, the electronic device can sense the spatial motion of the electronic device by using an acceleration sensor, a gyro sensor, and a camera module which are provided in the electronic device. That is, in this exemplary embodiment, the electronic device can sense that there is the spatial motion of the electronic device.

The electronic device having sensed that there is the spatial motion of the electronic device can determine the movement or non-movement of a subject being displayed (step 702). In detail, the electronic device can determine whether the subject being displayed on a touch screen of the electronic device is a fixed subject or is a moving subject.

The electronic device having determined the movement or non-movement of the subject being displayed can identify that the subject being displayed has been moved (step 703). In detail, when the subject is moved, the electronic device can identify that the subject being displayed on the touch screen of the electronic device has been moved.

After that, the electronic device can sense that the subject is moving concurrently with the spatial motion (step 704). For example, assume that the electronic device has sensed a spatial motion of the electronic device being moving to the right, and has sensed that the subject being displayed on the touch screen of the electronic device is moving. In the aforementioned assumption, after sensing that there is the spatial motion of the electronic device, the electronic device can sense the sensed spatial motion and that the subject being displayed is being moved, to automatically focus the subject being moved. That is, the electronic device may not perform CAF by sensing the spatial motion of the electronic device. In detail, the electronic device may not perform CAF by sensing the spatial motion of the electronic device irrespective of the movement or non-movement of the subject being displayed on the touch screen of the electronic device.

Finally, the electronic device can focus the subject being moved (step 705). The conventional electronic device failed to sense a spatial motion of the electronic device. In detail, the conventional electronic device sensed only the movement or non-movement of a subject being displayed on a touch screen of the electronic device irrespective of the spatial motion of the electronic device. In the aforementioned assumption, the conventional electronic device had a problem that, when the subject being displayed on the touch screen of the electronic device was moved, the electronic device continuously performed CAF because a range of a variation of a numeral obtained going through a filter provided in the electronic device was constant. In detail, because the range of the numeral obtained going through the filter of the electronic device was constant although the subject being displayed on the touch screen of the electronic device was moved, the conventional electronic device continuously performed CAF to focus the continuously moving subject. Accordingly, there was a problem that, when the electronic device played a taken video, the continuously performed CAF brought about a continuous change of screen focusing, causing inconvenience to a user who is seeing the played picture. Unlike this, the electronic device according to the present disclosure has an advantage of, the moment the electronic device senses a spatial motion of the electronic device, not performing CAF by sensing the spatial motion of the electronic device irrespective of the movement or non-movement of the subject being displayed on the touch screen of the electronic device.

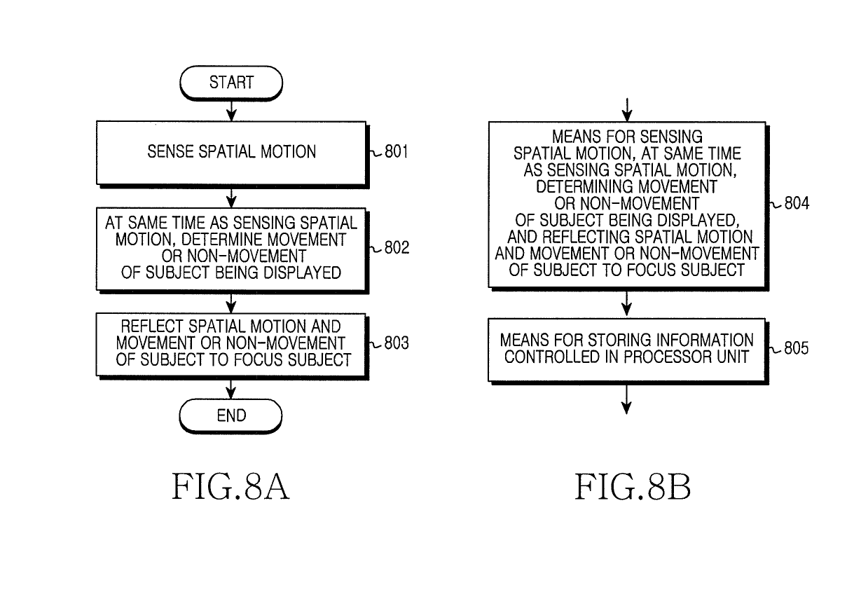

FIG. 8A illustrates a flowchart of a method of operating an electronic device reflecting a spatial motion to focus a subject according to an exemplary embodiment of the present disclosure.

First, the electronic device can sense a spatial motion (step 801). In detail, the electronic device according to the present disclosure can sense the spatial motion of the electronic device by using a sensor provided in the electronic device. Desirably, the electronic device can sense the spatial motion of the electronic device by using an acceleration sensor and a gyro sensor which are provide in the electronic device. Also, the electronic device can sense the spatial motion of the electronic device through a motion of a picture being displayed on the touch screen of the electronic device by using a camera module provided in the electronic device. That is, the electronic device can sense the spatial motion of the electronic device by using the acceleration sensor, the gyro sensor, and the camera module which are provided in the electronic device.

At the same time as sensing the spatial motion of the electronic device, the electronic device can determine the movement or non-movement of a subject being displayed (step 802). In detail, the electronic device can detect a first focus value of the subject being displayed, after the lapse of a set time, detect a second focus value of the subject, and sense a variation of the detected first focus value and second focus value to determine the movement or non-movement of the subject. Here, sensing the variation of the first focus value and second focus value detected in the electronic device to determine the movement or non-movement of the subject can be defined as sensing the variation of the sensed first focus value and second focus value and then determining the movement or non-movement of the subject depending on whether the sensed variation is equal to or is greater than a set variation. That is, when the variation sensed in the electronic device is determined equal to or greater than the set variation, the electronic device can identify that the subject displayed on the touch screen of the electronic device has been moved. In the same meaning, when the variation sensed in the electronic device is determined less than the set variation, the electronic device can identify that the subject displayed on the touch screen of the electronic device has been fixed.

After that, the electronic device can reflect the spatial motion of the electronic device and the movement or non-movement of the subject to focus the subject (step 803). In detail, it can be three cases:

First case is that there is not the motion of the electronic device and the subject being displayed on the touch screen of the electronic device is fixed;

Second case is that there is the motion of the electronic device and the subject being displayed on the touch screen of the electronic device is fixed; and

Third case is that there is the motion of the electronic device and the subject being displayed on the touch screen of the electronic device is moved.

In each case, the electronic device can reflect the spatial motion of the electronic device and the movement or non-movement of the subject to focus the subject.

FIG. 8B illustrates a diagram of an apparatus of an electronic device reflecting a spatial motion to focus a subject according to an exemplary embodiment of the present disclosure.

First, a processor unit of the electronic device can sense a spatial motion, at the same time as sensing the spatial motion, determine the movement or non-movement of a subject being displayed, and reflect the spatial motion of the electronic device and the movement or non-movement of the subject to focus the subject (804). In detail, the processor unit can sense the spatial motion of the electronic device by using an acceleration sensor, a gyro sensor and a camera module which are provided in the electronic device. After that, at the same time as sensing the spatial motion, the processor unit can determine the movement or non-movement of the subject being displayed, and reflect the spatial motion of the electronic device and the movement or non-movement of the subject to focus the subject.

After that, a memory of the electronic device can store information controlled in the processor unit (805). The memory can store software. A software constituent element can include an Operating System (OS) module, a communication module, a graphic module, a user interface module, an MPEG module, a camera module, one or more application modules and the like.

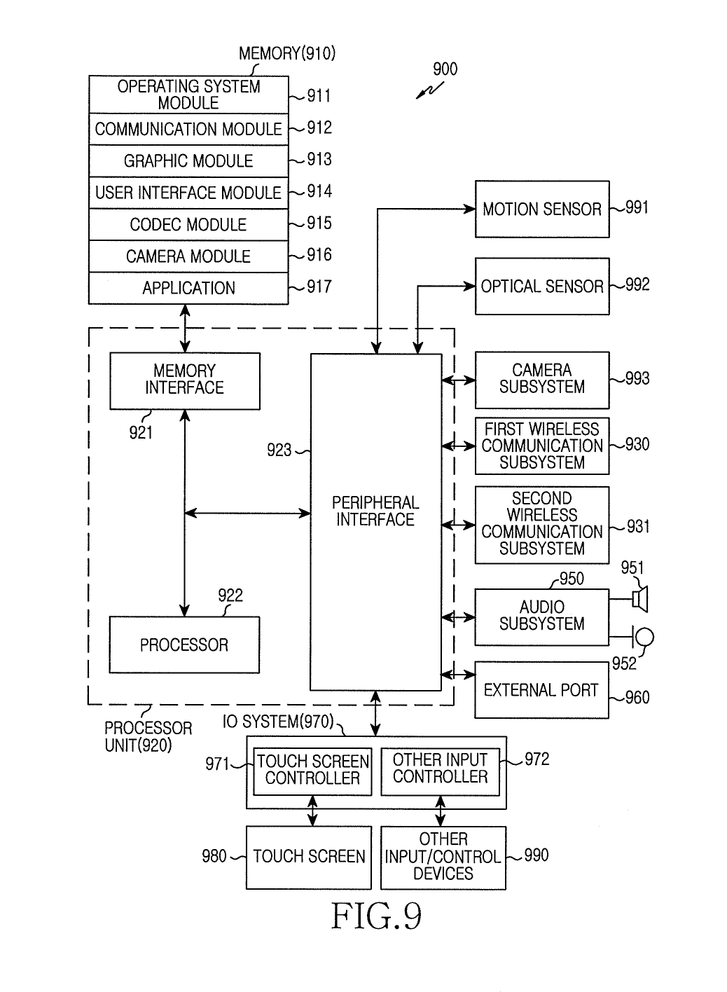

FIG. 9 illustrates a block diagram of a construction of an electronic device according to an exemplary embodiment of the present disclosure. This electronic device 900 can be a portable electronic device, and can be a device such as a portable terminal, a mobile phone, a mobile pad, a media player, a tablet computer, a handheld computer, or a Personal Digital Assistant (PDA). Also, the electronic device may be any portable electronic device including a device combining two or more functions among these devices.

The electronic device 900 includes a memory 910, a processor unit 920, a first wireless communication sub system 930, a second wireless communication sub system 931, an audio sub system 950, a speaker 951, a microphone 952, an external port 960, an Input Output (10) sub system 970, a touch screen 980, and other input or control devices 990. The memory 910 and the external port 960 can be used in plurality.

The processor unit 920 can include a memory interface 921, one or more processors 922, and a peripheral interface 923. According to cases, the whole processor unit 920 is also called a processor. In the present disclosure, the processor unit 920 senses a spatial motion, at the same time as sensing the spatial motion, determines the movement or non-movement of a subject being displayed, and reflects the spatial motion of the electronic device and the movement or non-movement of the subject to focus the subject. Also, the processor unit 920 can sense the spatial motion by using an acceleration sensor and a gyro sensor, and can sense the spatial motion through a motion of a picture being displayed. Also, the processor unit 920 can detect a first focus value of the subject being displayed, detect a second focus value of the subject after the lapse of a set time, and sense a variation of the detected first focus value and second focus value to determine the movement or non-movement of the subject. Also, the processor unit 920 can sense the variation of the sensed first focus value and second focus value to determine the movement or non-movement of the subject depending on whether the sensed variation is equal to or is greater than a set variation. Also, when the sensed variation is determined equal to or greater than the set variation, the processor unit 920 can identify that the subject has been moved and, when the sensed variation is determined less than the set variation, the processor unit 920 can identify that the subject has been fixed. Also, the processor unit 920 can capture a first picture being displayed at a set first time, capture a second picture being displayed at a set second time after the lapse of the set first time, compare the captured first picture and second picture to distinguish a moved first subject and a fixed second subject, and focus the fixed second subject. Also, the processor unit 920 can sense that there is the spatial motion, sense that the subject being displayed is being moved according to the sensed spatial motion, and focus the subject being moved. Also, the processor unit 920 can sense that there is the spatial motion, sense that the subject is being moved concurrently with the spatial motion, and focus the subject being moved.

The processor 922 executes various software programs and performs various functions for the electronic device 900, and also performs processing and control for voice communication and data communication. Also, in addition to this general function, the processor 922 plays even a role of executing a specific software module (i.e., an instruction set) stored in the memory 910 and performing specific various functions corresponding to the software module. That is, the processor 922 interworks with the software modules stored in the memory 910 and carries out a method of an exemplary embodiment of the present disclosure.

The processor 922 can include one or more data processors, image processors, or COder/DECoders (CODECs). The data processor, the image processor, or the CODEC may be constructed separately. Also, the processor 922 may be composed of several processors performing different functions. The peripheral interface 923 connects the IO sub system 970 of the electronic device 900 and various peripheral devices thereof to the processor 922 and to the memory 910 through the memory interface 921.

Various constituent elements of the electronic device 900 can be coupled with one another by one or more communication buses (not denoted by reference numerals) or stream lines (not denoted by reference numerals).

The external port 960 direct connects an electronic device (not shown) to other electronic devices or indirect connects to other electronic devices over a network (for example, the Internet, an intranet, a Wireless Local Area Network (WLAN) and the like). For example, the external port 960 refers to, although not limited to, a Universal Serial Bus (USB) port, a FIREWIRE port or the like.

A motion sensor 991 and an optical sensor 992 are coupled to the peripheral interface 923 and enable various functions. For instance, the motion sensor 991 and the optical sensor 992 can be coupled to the peripheral interface 923 to sense a motion of the electronic device 900, sense a charge transfer, and sense a light from the exterior, respectively. In addition to this, other sensors such as a global positioning system, a temperature sensor, a biological sensor or the like can be coupled to the peripheral interface 923 and perform related functions.

A camera sub system 993 can perform a camera function such as picture and video clip recording.

The optical sensor 992 can use a Charged Coupled Device (CCD) device or Complementary Metal-Oxide Semiconductor (CMOS) device.

A communication function is performed through one or more wireless communication sub systems 930 and 931. The first wireless communication sub system 930 and the second wireless communication sub system 931 can include a radio frequency receiver and transceiver and/or an optical (e.g., infrared) receiver and transceiver. The first wireless communication sub system 930 and the second wireless communication sub system 931 can be distinguished according to a communication network in which the electronic device 900 communicates. For example, the communication network can include a communication sub system designed to operate through, although not limited to, a Global System for Mobile Communication (GSM) network, an Enhanced Data GSM Environment (EDGE) network, a Code Division Multiple Access (CDMA) network, a Wireless-Code Division Multiple Access (W-CDMA) network, a Long Term Evolution (LTE) network, an Orthogonal Frequency Division Multiple Access (OFDMA) network, a Wireless Fidelity (Wi-Fi) network, a Wireless interoperability for Microwave Access (WiMAX) network, a Bluetooth network or/and the like.

The audio sub system 950 can be coupled to the speaker 951 and the microphone 952 to take charge of input and output of an audio stream such as voice recognition, voice replication, digital recording, and telephony function. That is, the audio sub system 950 communicates with a user through the speaker 951 and the microphone 952. The audio sub system 950 receives a data stream through the peripheral interface 923 of the processor unit 920, converts the received data stream into an electric stream, and forwards the converted electric stream to the speaker 951. The speaker 951 converts the electric stream into human-audible sound waves and outputs the converted sound waves. The microphone 952 converts sound waves forwarded from human or other sound sources into electric streams. Also, the microphone 952 operates if any one second sensor among at least two second sensors senses that a thing is located within a set distance. The audio sub system 950 receives the converted electric streams from the microphone 952. The audio sub system 950 converts the received electric streams into audio data streams, and transmits the converted audio data streams to the peripheral interface 923. The audio sub system 950 can include a detachable earphone, headphone or headset.

The IO sub system 970 can include a touch screen controller 971 and/or other input controller 972. The touch screen controller 971 can be coupled to the touch screen 980. The touch screen 980 and the touch screen controller 971 can detect a contact and a motion or an interruption thereof, by using, though not limited to, not only capacitive, resistive, infrared and surface acoustic wave technologies for determining one or more contact points with the touch screen 980 but also any multi-touch sensing technology including other proximity sensor arrays or other elements. The other input controller 972 can be coupled to the other input/control devices 990. The other input/control devices 990 can be at least one or more buttons, a rocker switch, a thumb-wheel, a dial, a stick, a pointer device such as a stylus and/or the like.

The touch screen 980 provides an input output interface between the electronic device 900 and a user. That is, the touch screen 980 forwards a user's touch input to the electronic device 900. Also, the touch screen 980 is a medium for showing an output of the electronic device 900 to the user. That is, the touch screen 980 shows a visual output to the user. This visual output can be presented in form of a text, a graphic, a video, and a combination thereof.

The touch screen 980 can use various displays. For example, the touch screen 980 can use, although not limited to, a Liquid Crystal Display (LCD), a Light Emitting Diode (LED), a Light emitting Polymer Display (LPD), an Organic Light Emitting Diode (OLED), an Active Matrix Organic Light Emitting Diode (AMOLED), or a Flexible LED (FLED).

The memory 910 can be coupled to the memory interface 921. The memory 910 can include high-speed random access memory and/or non-volatile memory such as one or more magnetic disk storage devices, one or more optical storage devices, and/or flash memories (for example, Not AND (NAND) memories, Not OR (NOR) memories).

The memory 910 stores software. A software constituent element includes an OS module 911, a communication module 912, a graphic module 913, a user interface module 914, an MPEG module 915, a camera module 916, one or more application modules 917 and the like. Also, because the module, a software constituent element, can be expressed as a set of instructions, the module is also called an instruction set. The module is also called a program. The OS module 911 (for example, a built-in operating system such as WINDOWS, LINUX, Darwin, RTXC, UNIX, OS X, or VxWorks) includes various software constituent elements controlling general system operation. Control of the general system operation means memory management and control, storage hardware (device) control and management, power control and management and the like. This OS software performs even a function of making smooth communication between various hardware (devices) and software constituent elements (modules).

The communication module 912 can enable communication with other electronic device such as a computer, a server, a portable terminal and/or the like, through the first and second wireless communication sub systems 930 and 931 or the external port 960.

The graphic module 913 includes various software constituent elements for providing and displaying a graphic on the touch screen 980. The term ‘graphic’ is used as meaning including a text, a web page, an icon, a digital image, a video, an animation and the like.

The user interface module 914 includes various software constituent elements associated with a user interface. Further, the user interface module 914 includes information about how a state of the user interface is changed and in which conditions the change of the state of the user interface is carried out, and the like.

The CODEC module 915 can include a software constituent element related to encoding of a video file and decoding thereof. The CODEC module 915 can include a video stream module such as an MPEG module and/or H204 module. Also, the CODEC module can include several audio file CODEC modules such as AAA, AMR, WMA and the like. Also, the CODEC module 915 includes an instruction set corresponding to an embodiment method of the present disclosure.

The camera module 916 includes a camera-related software constituent element enabling camera-related processes and functions.

The application module 917 includes a browser, an electronic mail (e-mail), an instant message, word processing, keyboard emulation, an address book, a touch list, a widget, Digital Right Management (DRM), voice recognition, voice replication, a position determining function, a location-based service and the like.

Also, various functions of the electronic device 900 according to the present disclosure mentioned above and to be mentioned below can be executed by hardware including one or more stream processing and/or Application Specific Integrated Circuits (ASICs), and/or software, and/or a combination of them.

While the disclosure has been shown and described with reference to certain preferred embodiments thereof, it will be understood by those skilled in the art that various changes in form and details may be made therein without departing from the spirit and scope of the disclosure as defined by the appended claims.

What is claimed is:

1. A method for operating an electronic device, the method comprising:
sensing a spatial motion of the electronic device;
while sensing the spatial motion, determining movement or non-movement of a subject being displayed; and
reflecting the spatial motion of the electronic device and the movement or non-movement of the subject to focus the subject.

2. The method of claim 1, wherein sensing the spatial motion comprises sensing whether there is the spatial motion using an acceleration sensor and a gyro sensor.

3. The method of claim 1, wherein sensing the spatial motion comprises sensing the spatial motion through a motion of a picture being displayed.

4. The method of claim 1, wherein determining the movement or non-movement of the subject being displayed comprises:
detecting a first focus value of the subject being displayed;
after the lapse of a set time, detecting a second focus value of the subject; and
sensing a variation of the detected first focus value and the detected second focus value to determine the movement or non-movement of the subject.

5. The method of claim 4, wherein sensing the variation of the detected first focus value and the detected second focus value to determine the movement or non-movement of the subject comprises:
sensing a variation of the detected first focus value and the detected second focus value; and
determining the movement or non-movement of the subject depending on whether the sensed variation is equal to or is greater than a set variation.

6. The method of claim 5, wherein determining the movement or non-movement of the subject depending on whether the sensed variation is equal to or is greater than the set variation comprises, when the sensed variation is determined equal to or greater than the set variation, identifying that the subject has moved.

7. The method of claim 5, wherein determining the movement or non-movement of the subject depending on whether the sensed variation is equal to or is greater than the set variation comprises, when the sensed variation is determined less than the set variation, identifying that the subject has been fixed.

8. The method of claim 1, wherein reflecting the spatial motion of the electronic device and the movement or non-movement of the subject to focus the subject comprises:
capturing a first picture being displayed at a set first time;
after the lapse of the set first time, capturing a second picture being displayed at a set second time;
comparing the captured first picture and second picture to distinguish a moved first subject and a fixed second subject; and
focusing the fixed second subject.

9. The method of claim 1, wherein reflecting the spatial motion of the electronic device and the movement or non-movement of the subject to focus the subject comprises:
sensing the spatial motion;
sensing that the subject being displayed is being moved according to the sensed spatial motion; and
focusing the subject being moved.

10. The method of claim 1, wherein reflecting the spatial motion of the electronic device and the movement or non-movement of the subject to focus the subject comprises:
sensing the spatial motion;
concurrently with the spatial motion, sensing that the subject is being moved; and
focusing the subject being moved.

11. An electronic device comprising:
a processor unit configured to sense a spatial motion of the electronic device; while sensing the spatial motion, determine movement or non-movement of a subject being displayed; and reflecting the spatial motion of the electronic device and the movement or non-movement of the subject to focus the subject; and
a memory configured to store information controlled in the processor unit.

12. The device of claim 11, wherein the processor unit is configured to sense whether there is the spatial motion using an acceleration sensor and a gyro sensor.

13. The device of claim 11, wherein the processor unit is configured to sense the spatial motion through a motion of a picture being displayed.

14. The device of claim 11, wherein the processor unit is configured to detect a first focus value of the subject being displayed; after the lapse of a set time, detect a second focus value of the subject; and sense a variation of the detected first focus value and the detected second focus value to determine the movement or non-movement of the subject.

15. The device of claim 14, wherein the processor unit is configured to sense a variation of the detected first focus value and the detected second focus value, and determine the movement or non-movement of the subject depending on whether the sensed variation is equal to or is greater than a set variation.

16. The device of claim 15, wherein, when the sensed variation is determined equal to or greater than the set variation, the processor unit is configured to identify that the subject has moved.

17. The device of claim 15, wherein, when the sensed variation is determined less than the set variation, the processor unit is configured to identify that the subject has been fixed.

18. The device of claim 11, wherein the processor unit is configured to capture a first picture being displayed at a set first time; after the lapse of the set first time, capture a second picture being displayed at a set second time; compare the captured first picture and second picture to distinguish a moved first subject and a fixed second subject, and focus the fixed second subject.

19. The device of claim 11, wherein the processor unit is configured to sense the spatial motion, sense that the subject being displayed is being moved according to the sensed spatial motion, and focus the subject being moved.

20. The device of claim 11, wherein the processor unit is configured to sense the spatial motion; concurrently with the spatial motion, sense that the subject is being moved; and focus the subject being moved.
